(19) United States
(12) Patent Application Publication
(10) Pub. No.: US 2020/0406596 A1
(43) Pub. Date: Dec. 31, 2020

(54) Oil-Resistant Composite Material

(71) Applicant: Lohmann - koester GmbH & Co. KG, Altendorf (DE)

(72) Inventors: Maximilian WAGNER, Nuernberg (DE); Clemens KEILHOLZ, Kirchehrenbach (DE); Dominik SCHMIDT, Nuernberg (DE)

(73) Assignee: Lohmann - koester GmbH & Co. KG, Altendorf (DE)

(21) Appl. No.: 16/976,602

(22) PCT Filed: Feb. 28, 2019
(86) PCT No.: PCT/EP2019/055056

§ 371 Date: Aug. 28, 2020

(30) Foreign Application Priority Data
Feb. 28, 2018 (DE) 10 2018 104 525.5

(51) Int. Cl. B32B 27/32; B32B 5/02; B29C 48/00; B32B 27/30

(52) U.S. Cl. CPC B32B 27/327; B32B 5/022; B29C 48/0021; B32B 27/302; B32B 2274/00; B32B 2405/00; B32B 2555/02; B32B 2307/54; B32B 2323/04; B32B 2323/10; B32B 2250/02

(57) ABSTRACT

A oil-resistant two-dimensional composite material, consisting in a middle layer and at least one outer layer or outer layers, arranged above and/or underneath, where the outer layers consist of materials selected from non-woven fabrics and are not attached to the middle layer by means of a separate adhesive. The middle layer has a one-layered structure, and whereas the middle layer consists in a polymer blend, which includes at least one SIS thermoplastic elastomer and at least one olefinic polymer.

### CROSS-REFERENCE TO RELATED APPLICATIONS

This application is a national stage U.S. patent application of International Application No. PCT/EP2019/055056, filed Feb. 28, 2019, and claims foreign priority to German Patent Application No. 10 2018 104 525.5, filed on Feb. 28, 2018, the entirety of each of which is incorporated herein by reference.

### TECHNICAL FIELD

Described is an oil-resistant, elastic, two-dimensional composite material (laminate) and a method for the production thereof.

### DESCRIPTION OF THE RELATED TECHNOLOGY

“Non-woven fabrics” or “non-wovens”, see also Ullmann's Enzyklopädie der technischen Chemie [Encyclopaedia of technical chemistry], 3rd ed., vol. 17, p. 287 et seqq.) and composite materials of elastomers and non-woven fabrics are frequently used in the art, in particular in the fields of sanitary, personal care and hygiene products. Here, the non-woven fabric inter alia provides for a comfortable haptic performance, in particular where items are involved that are in contact with the wearer's skin for an extended period of time, whereas further elastomers connected to the non-woven fabric—often a film made of a suitable elastomer polymer material—contribute additional desired properties, such as increased mechanical strength whilst providing flexibility and impermeability for aqueous liquids to the properties of the composite material.

One prevalent challenge in this context consists in the fact that the corresponding materials often come into contact with body care products containing both an aqueous and an oily phase (skin care creams and emulsions) or that are even based entirely on an oily carrier base (body oils), Under these circumstances, in particular those components of the composite material consisting of elastomer polymer materials are subjected to additional stress as obviously different polymers exhibit different degrees of resilience with respect to oily liquids. Oily liquids (or the oily components of the personal care products mentioned above) first of all may diffuse into such polymer material and, for example, adversely affect its mechanical properties due to their presence alone; secondly also interference cannot be ruled out between oily liquids and other components (e.g. colourants, fillers, plasticisers, etc.) of the polymer materials—insofar as there are any. In the worst-case scenario, the product consisting of the composite material is destroyed or may lose its advantageous properties. Reduced tensile strength for example results in the formation of holes in the polymer materials, causing the composite material as a whole to lose its barrier properties with respect to aqueous liquids.

The prior art provides various methods to solve this problem by making such composite materials more resilient against the influence of oily liquids.

WO 2004/060665 suggests to attach a central elastomer film on both sides to the non-woven fabric by adhesion, with the adhesive being resistant to oily liquids. The resulting composite material includes a total of five layers (non-woven fabric-adhesive-elastomer film-adhesive-non-woven fabric), with the adhesive layers providing for resistance against oily liquids.

WO 2008/038168 introduces a corresponding composite material elastic film, comprising a semi-crystalline propylene-based polymer with a density of equal to or less than 0.88/cm³. The oil-resistance here sterns from the chemical nature of the elastic film.

In EP 3 187 333 A, an oil-resistant laminate is described with two outer non-woven fabric layers and a central elastomer layer, whereas the elastomer layer itself consists in at least two layers, with at least one layer representing an olefin-based elastomer responsible for the oil-resistance.

### DETAILED DESCRIPTION OF THE EMBODIMENTS

Various embodiments now will be described more fully hereinafter with reference to the accompanying drawings, which form a part hereof, and which show, by way of illustration, specific embodiments by which the invention may be practiced. The embodiments may, however, be embodied in many different forms and should not be construed as limited to the embodiments set forth herein; rather, these embodiments are provided so that this disclosure will be thorough and complete, and will fully convey the scope of the embodiments to those skilled in the art.

Throughout the specification and claims, the following terms take the meanings explicitly associated herein, unless the context clearly dictates otherwise. The term “herein” refers to the specification, claims, and drawings associated with the current application. The phrase “in an embodiment” as used herein does not necessarily refer to the same embodiment, though it may. Furthermore, the phrase “in further embodiment” or “a further development” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references.

The present disclosure provides an oil-resistant two-dimensional composite material, consisting in a middle layer and at least one outer layer or outer layers, arranged above and/or underneath, whereas the outer layers consist of materials selected from non-woven fabrics and are not attached to the middle layer by means of a separate adhesive, whereas the middle layer has a one-layered structure, and whereas the middle layer consists in a polymer blend, which includes at least one thermoplastic elastomer from the group of styrene/isoprene/styrene/triblock copolymers (SIS) and moreover at least one polymer from the group of olefinic polymers, whereas the olefinic polymers are selected from the group of polyethylenes and polypropylenes and copolymers of ethylene and propylene and thermoplastic elastomer polyolefines (TPOs), and whereas the polymer blend of the middle layer includes no added plasticiser(s), particularly mineral oils.

In one embodiment, the olefinic polymers of the polymer blend of the middle layer are selected from the group of the polyethylenes and polypropylenes and copolymers of ethylene and propylene produced using metallocene catalysis.

In another embodiment, the olefinic polymer of the polymer blend of the middle layer is a polypropylene or a copolymer of ethylene and propylene.

In yet another embodiment, the polymer blend of the middle layers includes no further polymer components apart from the SIS triblock copolymers and the olefinic polymers as specified above. Non-polymeric adjuvants such as fillers, processing aids, waxes, pigments etc. may be present, though. In yet another embodiment, the polymer blend of the middle layer consists in a SIS triblock copolymer, an olefinic polymer and optionally one or several of said adjuvants.

In yet another embodiment the material for the outer layers is selected from non-woven fabrics bonded using water jet bonding, also referred to as water entanglement or spun-lace. In yet another embodiment the material for the outer layers is selected from single-layer non-woven fabrics.

In yet another embodiment, the material for the outer layers is selected from the group of single-layer non-woven fabrics that are produced using a fibre material consisting in a uniform type of fibre. In yet another embodiment, the material for the middle layer is selected from the group of single-layer non-woven fabrics that are produced using a fibre material consisting in a blend of different types of fibre.

In yet another embodiment, the middle layer exhibits a thickness of 100 micrometres or less as measured by microscope, or in the range between 20 and 100 micrometres, or in the range between 20 and 70 micrometres.

In yet another embodiment, the SIS triblock co-polymer is characterised in that it contains less than 10% by weight or less than 1% by weight of diblock components. In yet another embodiment, the composite material consists in two outer layers attached to the middle layer, whereas one of the outer layers is arranged above the middle layer and a further outer layer is arranged underneath the middle layer.

In yet another embodiment, the composite material exhibits elastic capacity, measured by means of the testing method as illustrated below, of more than 9 N/100 mm. In yet another embodiment, the composite material exhibits elastic capacity of more than 10 N/100 mm or of more than 11N/100 mm.

In yet another embodiment, the present disclosure relates to a two-dimensional composite material (laminate), consisting in a middle layer and at least one outer layer or outer layers arranged above and/or underneath, whereas the outer layer(s) consist(s) in materials selected from non-woven fabrics and is/are not attached to the middle layer by means of an adhesive, whereas the middle layer exhibits a single layer structure, and whereas the static shear strength of a bond between an adhesive tape and the non-woven fabric of the outer layer increases more than ten-fold or more than twelve-fold subject to a curing time of the bond of fourteen days at 50° C.

In yet another embodiment, this composite material exhibits elastic capacity, measured by means of the testing method as illustrated below, of more than 9 N/100 mm.

In yet another embodiment, the composite material exhibits elastic capacity of more than 10 N/100 mm or of more than 11N/100 mm.

In yet another embodiment, this composite material is oil-resistant. In yet another embodiment, oil-resistance is determined according to the method specified in this description, whereas the composite material does not exhibit any hole formation within a period of three hours or of four hours or of six hours.

In yet another embodiment, the middle layer of the oil-resistant composite material includes the compositions as specified above.

The present disclosure moreover provides a method for producing the composite material in accordance with the present disclosure, which is characterised in that the middle layer is applied or introduced on or between the outer layer(s). To this end, first the failing extrusion film is brought together in a roller gap between two outer layers. Downstream, the outer layers can be bonded fully across the entire surface to the still plastic film by applying light clamping pressure by means of a bonding unit, which is arranged directly behind the extrusion unit. In the alternative, it is possible to press the outer layers deeper into the still plastic film than in the remaining areas by applying stronger clamping pressure in the selected areas. In this, the clamping pressure may also be exerted in a separate step, whilst the elastic film is in a plastic state. Subsequently, the composite material can be activated either partially or across its entire surface by way of pre-tensioning using conventional methods such as ring-rolling or contactless tensioning using a tensioning frame or something similar.

It was a surprising find that a composite material may obtain increased resistance against oily liquid (oil-resistance) if the middle layer is made of a polymer blend that includes at least one thermoplastic elastomer from the group of styrene/isoprene styrene triblock copolymers (SIS) and moreover at least one polymer, selected from the group of olefinic polymers, whereas the olefinic polymers are selected from the group of polyethylenes and polypropylenes and copolymers of ethylene and propylene and thermoplastic elastomer polyolefines (TPOs), and whereas the polymer blend of the middle layer includes no added plasticiser(s), in particularly mineral oils. In particular, a SIS triblock copolymer may be used that includes less than 10% by weight or less than 1% per weight of diblock components, whereas this content of diblock components may be determined using methods known in the art (such as, e.g. gel permeation chromatography).

Plasticisers make materials softer and more flexible. All of the plasticising agents known in the art that are used for this purpose and that the skilled person is familiar with can be summarised under the term “plasticiser” within the meaning of the present description.

This includes, inter glia, poly-alpha-olefins (e.g. amorphous poly-alpha-olefins), (functionalised) oligomers such as oligobutadiene, -isoprene, liquid nitrile rubbers, liquid terpene resins, plant and animal oils and fats, ester plasticisers such as, e.g. phthalates, adipates, mellitates, phosphor containing esters or functionalised acrylates.

The group of plasticisers also includes mineral oils paraffinic, aromatic or naphthenic in nature. One sub-category of these mineral oils are also referred to as paraffin oils or white oils (e.g. Catanex S or T by the company Shell). Part of them are technical white oils that are barely hydrogenated or just once and may contain traces of aromatic hydrocarbon compounds (e.g. Flavex by the company Shell).

Medical white oils constitute another part, they are highly purified, i.e. repeatedly refined paraffin oils without residues such as aromatic hydrocarbons and sulphur compounds (e.g. Risella X or Ondina X by Shell). White oils are therefore preferably used in products requiring a high degree of purity without contamination by substances potentially presenting a health risk, such as e.g. aromatic carbohydrates, i.e. in the cosmetics or hygiene industry.

It was moreover surprisingly found out that the absence of such plasticisers in the middle layer increases the durability of the bond between a composite material according to the present disclosure and an adhesive tape coated with an adhesive glue. Such bonds using adhesive glues or tapes are relevant in practice. In the hygiene products mentioned already in the introduction, the closure that fixes the item in the position as it is worn and holds it there is frequently effected by such a bond—adhesive tape applied directly on the non-woven fabric layer of the composite material. It is advantageous if such a bond is not released prematurely, as this will cause loss of wear comfort or may even require premature replacement of the hygiene product. Without aiming to be bound by a theoretical explanation, it must be assumed that in the case of middle layers containing plasticisers (and especially middle layers containing mineral oil) in the composite materials, the plasticiser will diffuse into the adhesive layer of the adhesive tape, which will negatively affect the adhesive properties of the adhesive. Given that no plasticisers are used in the composite materials according to the present disclosure, no such diffusion can occur.

In one embodiment, the composite material is characterised in that the static shear strength of a corresponding bond between an adhesive tape and the non-woven layer increases more than ten-fold or more than twelve-fold subject to a curing time of the bond of fourteen days at 50° C. as described in the test illustrated below.

Non-woven fabrics suitable for use with embodiments of the present disclosure are essentially all non-woven fabrics that can be combined with the materials of the middle layer according to the disclosure using the production method according to the present disclosure (extrusion lamination). Such non-woven fabrics as well as methods for their production are known in the art (cf. Ullmann's Enzyklopädie der technischen Chemie, 3rd edition, volume 17, page 287et seqq.; cf. also 5th edition, volume A17, chapter “Nonwoven Fabrics”, pages 565-587).

Essentially, any fibre material will qualify as a textile fibre material for the production of the non-woven fabrics for use as a component of the composite material according to the present disclosure that can be combined into a non-woven fabric using the known production methods, i.e. that can be combined into a fabric of staple fibres and endless fibres. Only mineral fibres and glass fibres cannot be used. Both natural and semi-synthetic or synthetic fibres may be used. Similarly, uniform fibre materials as well as blends of different fibre materials can be used. The skilled person is familiar with suitable fibre materials and the criteria for their use based on their general technical knowledge (cf. Ullmann l.c.).

Examples of suitable fibre materials are fully synthetic fibres such as polyethylene, polyethylene terephthalate, polypropylene, polyester, viscose, polyamide, cotton or wool fibres, In one embodiment, the fibres consist in polypropylene.

Moreover, two-component fibres are known in the field of non-woven fabric production, which may provide the resulting non-woven fabric with particular properties. One sub-group of these fibres are the two-component fibres made of two synthetic polymers, i.e. polyester polyamide, polyester polypropylene, polyamide 6-polyamide 6.6 etc. Moreover, it is known that such two-component fibres can be modified such already during initial production that the two components are located in precisely defined spatial sections of the fibres (e.g. as core and envelope, as segments. etc.). Any and all such embodiments are generally comprised by the non-woven fabrics suitable for the production of composite materials in accordance with the present disclosure.

Moreover, non-woven fabrics may be produced using known methods of the art both as single-layer or multi-layer fabrics, i.e. the fibre materials may vary within the cross-section of the non-woven fabric. Both single-layer and multi-layer non-woven fabrics are comprised in respect of the production of the composite materials in accordance with the present disclosure.

In one embodiment, the non-woven fabrics constitute single-layer non-woven fabrics, i.e. the type and composition of the fibres does not vary within the cross-section of the outer layer. Various methods can be used in the production of the non-woven fabrics to obtain a bond among the fibres and with the backing material, respectively. Here, mechanical, adhesive and thermal methods are used. As a general rule, all of these methods are suitable for the production of the non-woven fabrics for the use in the composite materials in accordance with the present disclosure.

In yet another embodiment, the non-woven fabrics are selected from the group of non-woven fabrics bonded using water jet bonding (also referred to as water entanglement or spun-lace), i.e. they consist in a fabric made of staple fibres, “carded fibres” or endless fibres. This production method is characterised in particular by the fact that it is exceptionally suitable for obtaining non-woven fabrics with pre-defined patterns (e.g. hole or sieve patterns) depending on the number and arrangement of the water jets. That way, the fibres are swirled in the fabric by the penetrating water jets.

Composite materials according to the invention can be produced using the method of extrusion lamination as known in the art, whereas the polymer blend of the middle layer is applied/inserted on/into the non-woven fabric layer(s), whereas an immediate and direct bond is created between the middle layer and the non-woven fabric layer(s) when the material cools down.

The properties of the composite materials according to the present disclosure are determined using the following test methods.

Oil-Resistance Test:

A square test section of the composite material (70×70 mm) is clamped into a metal rail at two opposing ends and stretched 100% by perpendicular tension, i.e. up to a length of 140 mm in the direction of tensioning. A droplet of the test liquid weighing 0.030 g is applied to the tensioned test section using a dropping pipette. The test section is visually inspected repeatedly over a period of three hours. If after three hours no mechanical changes (holes, tears etc.) have occurred at the application site or around the application site, the material is considered oil-resistant according to the definition used here.

The standardised test liquids used are almond oil (CAS-No. 90320-37-9, relative density of 0.916 (20° C.)., acid count≤1.0 mg KOH/g and a peroxide count≤5) and paraffin oil (by the company VWR Chemicals, ref. no. 301440ZK), i.e. oils frequently used in skincare products. Oil-resistance vis-à-vis either of those two oils is sufficient to define resistance within the meaning of this description.

Elastic Capacity Test:

A test section of the composite material (width: 130 mm—“original width”, length: 90 mm) is damped into a tensioning device (lateral to the machine direction, distance between clamps: 70 mm) and subjected to the following tensioning-release-cycle:
1. Pre-tensioning with a force of 0.1 N subject to tensile speed of 150 mm/min.
2. Tensioning 1: Elongation from 0% to 100% at a tensile speed of 500 mm/rein. Elongation of 100% maintained for 10 seconds. Measurement value: “tension 1” in N at 50% elongation.
3. Release 1: Elongation from 100% to 0% at a release speed of 150 mm/min.
4. Tensioning 2: Elongation from 0% to 100% at a tensile speed of 500 mm/min.
5. Release 2: Elongation from 100% to 0% at a release speed of 150 mm/min. Elongation of 0% maintained for 60 seconds.
6. Tensioning 3: Elongation to 100% at a tensile speed of 500 mm/min.
7. Release 3: Elongation from 100% to 0% at a release speed of 150 mm/min. Measurement value: “tension 3” in N at 50% elongation.

Elastic capacity is calculated according to formula (1):

“Tensioning 1” [N]−“Tensioning 3” [N]=Elastic Capacity [N] (1)

Stability Test of the Bond (Static Shear Test):

1. Objective of the Test

Check anchoring of a bonding material according to the present disclosure with an adhesive tape (for example: diaper side panel and diaper tape) and their creep subjected to [elevated] temperature.

2. Test Material/Climate Control

Sample: at least 24 h

Climate control: 23±2° C. and 50±5% relative humidity (RT)

3. Equipment

Shear stand with timer, incubator (37° C.), 1000 g weights, coil cradle (2.5 kg pressure roller)

4. Test Parameters

Adhesive tape: The adhesive tape used in this test (CP 1 M 50 by the company Lohmann-Koester) consists in a PP spun-bonded fabric at 60 g/m², which is coated with a solvent-free, UV curable silicone and HMPSA applied on the opposite side (pressure-sensitive hotmelt) with an application weight of 50 g/m² and processing temperature of 180° C., viscosity at 180° C. of 32850 mPas and immediate adhesive force (quickstick) on steel of 27 N/25 mm (test method described in the annex).

Sample width of the adhesive tape (tape used here: Diaper tape CP 1 M 50 by the company Lohmann-Koester): 25 mm

Sample width of the composite material (e.g. diaper side panel material (e.g. ESP)): 60 mm (indicate clearly in case of deviation)

Direction of tensioning: lateral in respect of the machine direction of the composite material

Roll-over: 2.5 kg-300 mm/min., 1× back and forth

Tensioning: 1000 g

Tensioning angle: 180°

Testing temperature: 37° C.

5. Test Start

A rectangular section is cut from the composite material (e.g. diaper side panel) laterally in respect of the machine direction. For cutting, the adhesive tape (e.g. diaper tape) is attached to silicone paper and cut out transversely in respect of the machine direction. The cut has to be clean and straight. After cutting, the adhesive tape is immediately laminated onto one end of the composite material. The surface of the overlap is 166 mm×25 mm. Subsequently, the sample is rolled over with the roller.

A hole is punched centrally in the non-laminated part of the adhesive tape and secured with clamps [sic]. [At] the other end of the composite material is supported with a 14 mm wide coated Velcro [sic] and secured with clamps.

6. Dwell Time Before Tests

Shear strength is determined for non-cured samples without observation of any particular wait time. For the curing step they are clamped between two Pertinax plates (100 mm×260 mm×8 mm) and stored for the pre-determined curing time at increased temperature in the oven subjected to 2×5 kg of weight.

Standard: the samples in this test are cured at 50° C. for 14 days.

7. Further Steps

The finished samples are then suspended in the shearing oven by means of a clamp of at least the same width as the sample, and they are weighted down. The weight is applied transversely to the grain of the composite material. It is important for this step to be carried out swiftly as otherwise the shearing oven will lose too much heat (temperature drops may result in higher shear values).

The time is measured from attaching the weight until the sample drops off.

8. Result

Analysis: here h/25 mm at 37° C. (h=hours, measured with an accuracy of two decimal places)

All Individual Values:

Mean value of the measurement values n and standard deviation s.

The values for cured and non-cured samples are compared, and a factor is determined to illustrate the change in shear strength after curing.

Annex: Determination of Immediate Adhesive Force for the Sample Adhesive Tape on Steel

1. Test Material/Climate Control

Sample: at least 4 h

Rolled items: at least 24 h

Climate control 23±2° C. and 50±5% relative humidity (RT)

2. Equipment and Chemicals

Tensile test device with 90° sliding mechanism or magnetic fixture, extension strip (paper), special benzine 60/95 for plate cleaning (not for testing plates coated with adhesive), testing plate 50 mm width (e.g. AFERA steel by the company Rocholl).

3. Testing Parameters

Sample width: 25 mm (indicate clearly in case of deviation)

Sample length: 250 mm (20 mm at the end masked=210 mm)

Testing speed: Down 300 mm/min

Up 300 mm/min

Peel-off angle: 90°

Distance between clamps: 1 10 mm (upper clamp to testing plate)

Distance downwards: 65 mm

Distance upwards: until the adhesive tape is complete removed from the testing plate

Separation distance: 50 mm width of the testing plate)

Holding time: 0 seconds

4. Test Initiation

The adhesive is cut in strips of 25 mm width, along with the running direction, 250 mm length. If the adhesive tape comes without masking paper, it must be applied on silicone paper prior to cutting. The cut must be clean and straight (not on top of silicone paper!).

The immediate adhesive strength is determined without observation of any particular wait time.

5. Test Execution

The cover is removed from the side to be tested, the two ends are clamped into the upper clamp of the test device such that a loop is created (the ends of the adhesive tape are covered with paper in the area of the clamps).

The loop must be driven immediately onto the testing plate arranged in horizontal position until a contact surface of 25 mm×50 mm has been created (width of the testing plate: 50 mm). If the adhesive tape does not cover the entire width of the testing plate, the distance between the clamps must be reduced.

Once the contact surface has been rolled over, the loop must be lifted up again immediately.

6. Result

Mean value x from the number of measurement values n and standard deviation s.

Analysis: Fₘₐₓ: Maximum force in [N/25 mnn]

### DETAILED DESCRIPTION OF EMBODIMENTS

### Example 1

### Composite Material No. V1-5

The material of the middle layer consists in:

| V1-5 | Weight % |
|---|---|
| SIS | 20-30 |
| Poly(ethylene-co-propylene) | 60-80 |
| Additives such as colour pigments, | 0-10 |
| stabilisers, processing adjuvants such as | |
| waxes, lubricants | |

### Example 2

### Composite Material No. V1-6

The material of the middle layer consists in:

| V1-6 | Weight % |
|---|---|
| SIS | 30-40 |
| Poly(ethylene-co-propylene) | 50-70 |
| Additives such as colour pigments, | 0-10 |
| stabilisers, processing adjuvants such as | |
| waxes, lubricants | |

### Example 3 (Comparative Example)

### Composite Material No. V#129

The material of the middle layer consists in:

| #129 | Weight % |
|---|---|
| Styrene block copolymers | 40-60 |
| Mineral oil | 20-40 |
| Poly(ethylene-co-propylene) | 10-20 |
| Additives such as colour pigments, | 0-10 |
| stabilisers, processing adjuvants such as | |
| waxes, lubricants | |

### Example 4

### Oil Resistance Test

The composite materials according to examples 1-3 are tested for oil-resistance in accordance with the test described above using different test liquids. The results are listed in the following table 1:

TABLE 1
Results of the oil resistance test

| | | Composite | Composite |
|---|---|---|---|
| | Composite | material | material |
| | material | V1-5 | V1-6 |
| | #129 | (in accordance with | (in accordance with |
| | (comparative | the present | the present |
| Test oil | example | disclosure) | disclosure) |
| Almond | Hole | No hole | No hole |
| oil | formation | formation | formation |
| | within < | within 3 h | within 3 h |
| | 3 h | | |
| Paraffin | Hole | No hole | No hole |
| oil | formation | formation | formation |
| | within < | within 3 h | within 3 h |
| | 3 h | | |

The same test results were also obtained using different commercially available cosmetics products as test liquids including the following base oils (in part in the form of oil blends) in addition to the test oils as specified: Rapeseed oil, palm kernel oil or coconut oil, avocado oil, sunflower oil, olive oil, shea butter and/or calendula oil.

### Example 5

### Elastic Capacity Test

The composite materials according to examples 1-3 are tested for elastic capacity in accordance with the test described above. The results are listed in the following table 2:

TABLE 2
Results of the elastic capacity test

| Composite material | Elastic capacity [N] |
|---|---|
| #129 | 5.37 |
| V1-5 | 11.50 |
| V1-6 | 9.84 |

### Example 6

### Static Shear Resistance Test of a Bond Between the Composite Material and an Adhesive Tape

The composite materials according to examples 1-3 are tested for elastic capacity in accordance with the test described above. The diaper tape CP 1 M 50 by the company Lohmann-Koester was used as adhesive tape. The results are listed in the following table 3:

TABLE 3
Results of the static shear resistance test of a bond
between the composite material and adhesive tape.

| Composite material | Static shear strength [h] |
|---|---|
| # 129; uncured | 0.14 |
| # 129; cured 14 d @ 50° C. | 0.48 |
| # V1-5; uncured | 0.12 |
| # V 1-5; cured 14 d @ 50° C. | 3.1 |

The failure profile differs in the following aspects:

In Reference # 129 (uncured and cured) as el as in uncured V1-5 the tape shears off of the laminate (=adhesion failure).

In the cured samples #V1-5 (after 14 days) the tape no longer shears off of the laminate. The laminate splits instead. This means that cracks appear in the non-woven fabric at the laminate and that the non-woven fabric partially splits off from the elastic film. This means there is no adhesion failure between the tape and the surface of the compound (=non-woven fabric) but cohesion failure within the laminate. Adhesion to the compound is so high that it is destroyed.

This means that the sample of the composite material #V1-5, the polymer blend of which contains no added plasticisers and in particular no mineral oils, allows for a stable adhesive bond between the adhesive tape and the composite material that develops over time. This shows in the increase of the static shear strength, which manifests itself as the extension of the period until failure by a factor of 15.5.

The composite material #129 in turn prevents a deep bond from forming between the adhesive of the tape and the composite material over a certain storage period. (The consequence is adhesion failure.) Static shear strength increases only by a factor of about 3.5. This phenomenon is caused by the oil components in the formulation of the polymer blend of the composite material #129. The oil migrates to the surface of the adhesive.

1. An oil-resistant two-dimensional composite material, comprising:
a middle layer and at least one outer layer arranged above, underneath, or above and underneath the middle layer;
the outer layer comprising a non-woven fabric, wherein the at least one outer layer is neither fixed nor attached to the middle layer with a separate adhesive; and
the middle layer has a one-layered structure, and the middle layer comprises a polymer blend, the polymer blend comprising at least one thermoplastic elastomer selected from the group of styrene/isoprene/styrene/triblock copolymers (SIS) and at least one polymer selected from the group of olefinic polymers, wherein the olefinic polymers are selected from the group of polyethylene, polypropylenes, copolymers of ethylene and propylene, and thermoplastic elastomer polyolefines (TPOs), and wherein the polymer blend of the middle layer includes no added plasticiser.

2. The composite material claim 1, wherein the olefinic polymers of the polymer blend of the middle layer are selected from the group of the polyethylenes and polypropylenes and copolymers of ethylene and propylene produced using metallocene catalysis.

3. The composite material of claim 1 wherein the polyolefin of the polymer blend of the middle layer is a polypropylene or a copolymer of ethylene or propylene.

4. The composite material of claim 1, wherein the non-woven fabrics selected for the at least one outer layer is selected from a group of non-woven fabrics bonded by means of water jet bonding.

5. The composite material of the claim 1, wherein the non-woven fabrics selected for the at least one outer layer is selected from the group of single-layered non-woven fabrics.

6. The composite material of claim 5, wherein the fibers of the non-woven fabric comprise a uniform type of fiber or a blend of different types of fiber.

7. The composite material of the claim 1, wherein the middle layer has a thickness of 100 micrometers or less.

8. The composite material of claim 1, wherein the SIS triblock copolymer of the middle layer has less than 10% of diblock components.

9. The composite material of claim 1, comprising at least two of the outer layers, and the at least two outer layers are attached to the middle layer, wherein one of the outer layers is arranged above the middle layer and another of the outer layers is arranged underneath the middle layer.

10. The composite material of claim 1, wherein the composite material is cured, and a bond between an adhesive tape and the non-woven fabric of the at least one outer layer has a shear strength of at least 10 times that of an uncured composite material.

11. The composite material of claim 1, wherein the composite material comprise an elastic capacity of more than 9 N/100 mm.

12. (canceled)

13. The composite material of claim 7, wherein the middle layer has a thickness in the range between 20 and 100 micrometers, or in the range between 20 and 70 micrometers.

14. The composite material of claim 13, wherein the middle layer has a thickness in the range between 20 and 70 micrometers.

15. The composite material of claim 1, wherein the SIS triblock copolymer of the middle layer has less than 1% of diblock components.

16. The composite material of claim 10, wherein the composite material is cured, and a bond between an adhesive tape and the non-woven fabric of the at least one outer layer has a shear strength of at least 12 times that of an uncured composite material.

17. A method for preparing the composite material of the claim 1, the method comprising:
providing the middle layer; and
laminating the middle layer to the at least one outer layer by extrusion lamination.

18. The method of claim 17, wherein the method comprises:
curing the composite material for fourteen days at 50° C., whereby a shear strength of a bond between an adhesive tape and the non-woven fabric of the at least one outer layer increases more than ten-fold during the curing.

19. The method of claim 18, wherein the shear strength of the bond between an adhesive tape and the non-woven fabric of the at least one outer layer increases more than twelve-fold during the curing.
